(19) United States
(12) Patent Application Publication
(10) Pub. No.: US 2004/0239644 A1
(43) Pub. Date: Dec. 2, 2004

(54) Touch panel having colored dot spacers

(76) Inventor: Akihisa Nishioka, Shizuoka-ken (JP)

Correspondence Address: NATH & ASSOCIATES, PLLC, Sixth Floor, 1030 15th Street, N.W., Washington, DC, 20005, US

(21) Appl. No.: 10/671,571

(22) Filed: Sep. 29, 2003

(30) Foreign Application Priority Data
Mar. 25, 2003 (JP) 2003-083211

(51) Int. Cl. G09G 5/00

(52) U.S. Cl. 345/173

(57) ABSTRACT

Dot spacers, which are disposed between two transparent electrodes of a touch panel, are colored differently from one another and appropriately distributed so that the dot spacers are perceived by a viewer as representing a designed image pattern by color distinction, rather than just a geometric or random pattern. As a result, the viewer does not feel the pattern as annoying even if the dot spacers are noticeable or visible to the viewer.

### BACKGROUND OF THE INVENTION

1. Field of the Invention

The present invention relates to a touch panel used for inputting information into a computer and the like, and more particularly to a transparent touch panel of resistance film system.

2. Description of the Related Art

FIG. 4A is an exploded perspective view of a conventional touch panel of resistance film system (hereinafter referred to simply as “touch panel”), and FIG. 4B is a cross-sectional view of FIG. 4A taken along a line A-A′. As shown in FIGS. 4A and 4B, the conventional touch panel basically comprises: a first electrode 101 structured such that a pair of first electrode terminals 104, 104 in parallel to each other and a plurality of dot spacers 105 are formed on a first conductive layer 103 which is formed on one major surface of a first insulating substrate 102; and a second electrode 111 structured such that a pair of second electrode terminals 114, 114 in parallel to each other are formed on a second conductive layer 113 which is formed on one major surface of a second insulating substrate 112. The first and second electrodes 101 and 111 are disposed in parallel to each other with a predetermined clearance therebetween such that the first conductive layer 103 faces the second conductive layer 113 with the first electrode terminals 104, 104 oriented orthogonal to the second electrode terminals 114, 114, and are adhered to each other at their peripheries via an adhering layer 106. In this connection, a circuit pattern 115 for inputting/outputting signals from/to a control circuit (not shown) is formed on the second insulating substrate 112.

The touch panel functions such that one area of the outside surface of the first electrode 101 or the second electrode 111 (the second electrode 111 in the case of the touch panel of FIG. 4A) is pressed by touching, whereby the first and second conductive layers 103 and 113 come in contact with each other at one area corresponding to the area pressed and the coordinates of the contact area are detected. Specifically, a voltage is applied between the second electrode terminals 114 and 114 by the aforementioned control circuit and an electric potential at the contact area is read by the first electrode terminals 104, 104 thereby detecting its X-coordinate, and a voltage is applied between the first electrode terminals 104 and 104 and an electric potential at the contact area is read by the second electrode terminals 114, 114 thereby detecting its Y-coordinate. The dot spacers 105 are formed of insulating resin and so arranged as to keep the first and second conductive layers 103 and 113 from getting in contact with each other under a pressing force which is inadvertently applied on the second electrode 111 and which does not exceed a predetermined level, thus an incorrect input triggered by an accidental touching by a user or due to a deformation of the insulating substrates 102 and 112 is avoided.

The touch panel described above can detect the absolute coordinates of a pressing point (contact point), and therefore is often disposed over the display screen of, for example, a display device for a computer, such as an LCD (liquid crystal display) or a CRT (cathode ray tube), thereby enabling information to be inputted directly by touching to press an area of the touch panel corresponding to a given area of the display screen. The touch panel applied as described above must be transparent, and usually a glass plate, a transparent resin plate or film of PET (polyethylene terephthalate), or the like is used for the insulating substrates 102 and 112, and a transparent conductive material, such as ITO (indium tin oxide) thin film, is used for the conductive layers 103 and 113.

The dot spacers 105 are also formed of a transparent resin, but light rays passing through the touch panel are reflected or scattered at the surfaces of the dot spacers 105, which may undesirably make the presence of the dot spacers 105 perceivable to a viewer disturbing the display screen image viewed through the touch panel, thus resulting in deterioration of the product quality level. To solve this problem, dot spacers are formed with their dimension minimized thereby decreasing the light reflecting/scattering area in order to prevent the presence of the dot spacers from being perceivable to the viewer. For example, dot spacers of a plastic bead having a diameter of 5 to 30 μm are disclosed in Japanese Patent Publication No. H6-332606, or dot spacers having a bearing area of 0.01 mm² or less and a height of 30 μm or less are disclosed in Japanese Patent Publication No. H7-169367.

The dimension of the dot spacers, however, cannot be diminished indefinitely in view of their role of ensuring a prescribed clearance between the conductive layers for insulation, and the fact is that the dot spacers disclosed as mentioned above still cannot be completely unnoticeable, which leaves the users unsatisfied.

### SUMMARY OF THE INVENTION

The present invention has been made in light of the above circumstance and it is an object of the present invention to provide a touch panel which does not dissatisfy the users in spite of its dot spacers being not perfectly unnoticeable. The present invention is based on that even when the dot spacers are noticeable, the transparency of the touch panel is not impaired as a whole thus meaning that the function of inputting information while viewing the display screen is not lost, and therefore the intention of the present invention is to solve the above-mentioned problem by creating an agreeable impression to the viewer when the dot spacers are noticed.

In order to achieve the above object, according to a first aspect of the present invention, a touch panel comprises: first and second transparent electrodes disposed in parallel so as to face each other with a predetermined clearance therebetween; and a plurality of dot spacers disposed between the first and second transparent electrodes and distributed so as to form an image pattern consisting of one of a picture, character, symbol and figure, or a combination of any thereof. Consequently, the dot spacers work to form a designed image pattern, rather than a geometric or random pattern, so even if the dot spacers are visible to a viewer, the viewer does not perceive the image pattern as annoying. Thus, no special means to make the dot spacers unnoticeable is required to keep the product acceptable.

According to a second aspect of the present invention, in the touch panel of the first aspect, the plurality of dot spacers include a plurality of kinds each having a color different from others, and at least a part of the image pattern is formed by the color distinction of the dot spacers. Consequently, the dot spacers can be formed using the conventional techniques such as screen printing, photolithography, and the like, and the conventional equipment, thus enabling the touch panel to be economically produced. And the dot spacers can be formed of the same material and with the same dimension and arranged at the same spacing interval, whereby the mechanical and electrical characteristics of the touch panel can be readily maintained.

According to a third aspect of the present invention, in the touch panel of the first or second aspect, the plurality of dot spacers are distributed with variation in distribution density, and at least a part of the image pattern is formed by the variation in distribution density. Consequently, all the dot spacers including those forming the image pattern can be formed at a single process, which does not involve a cost increase compared with the conventional touch panel, and which keeps the dot spacers least noticeable.

According to a fourth aspect of the present invention, in the touch panel of the third aspect, dot spacers distributed with a low distribution density have a larger height than dot spacers distributed with a high distribution density. Consequently, the pressing force required to cause the first and second transparent electrodes to get in contact with each other can be uniformed, thereby achieving stable electrical and mechanical characteristics.

According to a fifth aspect of the present invention, in the touch panel of the third or fourth aspect, the plurality of dot spacers include primary dot spacers distributed with variation in distribution density and secondary dot spacers having a smaller bearing area than the primary dot spacers and arranged at areas where the primary dot spacers are distributed with a low distribution density. Consequently, the pressing force required to cause the first and second transparent electrodes to get in contact with each other can be uniformed, thereby achieving stable electrical and mechanical characteristics like in the fourth aspect.

### BRIEF DESCRIPTION OF THE DRAWINGS

FIG. 1A is a top plan view of a touch panel according to a first embodiment of the present invention;

FIG. 1B is a cross-sectional view of the touch panel of FIG. 1A taken along a line A-A;

FIG. 2A is a top plan view of a touch panel according to a second embodiment of the present invention;

FIG. 2B is a cross-sectional view of the touch panel of FIG. 2A taken along a line A-A′;

FIG. 3A is a top plan view of a touch panel according to a third embodiment of the present invention;

FIG. 3B is a top plan view of a touch panel according to a modified version derived from the third embodiment of the present invention;

FIG. 4A is an exploded perspective view of a conventional touch panel; and

FIG. 4B is a cross-sectional view of the conventional touch panel of FIG. 4A taken along a line A-A′.

### DETAILED DESCRIPTION OF THE PREFERRED EMBODIMENTS

Preferred embodiments of the present invention will hereinafter be discussed with reference to the accompanying drawings.

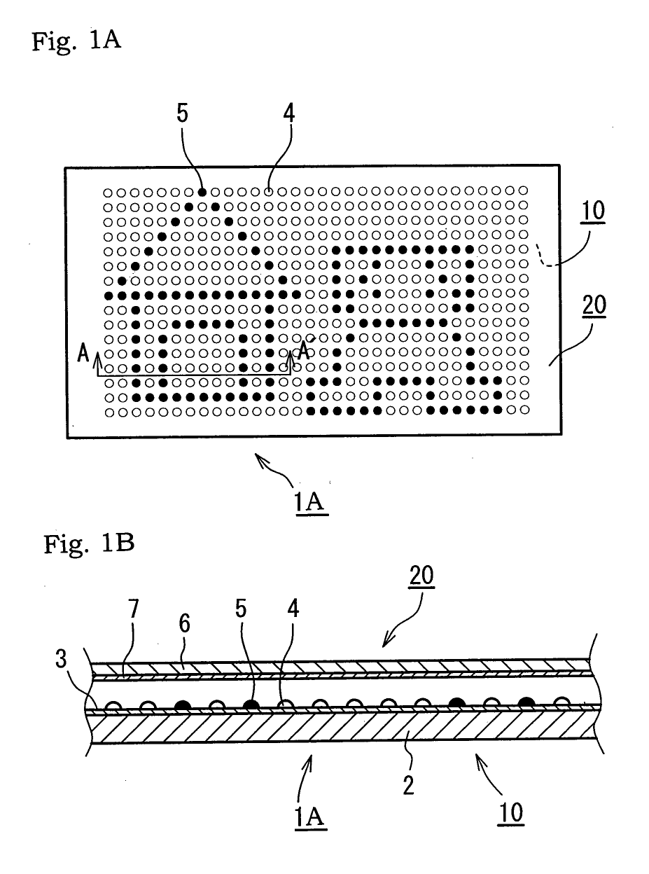

Referring to FIGS. 1A and 1B, a touch panel 1A according to a first embodiment generally comprises: a first transparent electrode 10; a second transparent electrode 20; and a plurality of dot spacers 4, 5. The first transparent electrode 10 is structured such that a first transparent conductive layer 3 of, for example, ITO thin film is formed by vapor deposition or sputtering on one major surface of a first transparent insulating substrate 2 of, for example, soda lime glass, and that the dot spacers 4, 5 are formed by printing or photolithography on the first transparent conductive layer 3. The second transparent electrode 20 is structured such that a second transparent conductive layer 7 of, for example, ITO thin film is formed by vapor deposition or sputtering on one major surface of a second transparent insulating substrate 6. The first and second electrodes 10 and 20 are disposed parallel to each other such that the first and second conductive layers 3 and 7 faces each other with a predetermined clearance therebetween.

Referring to FIG. 1A, the dot spacers include uncolored dot spacers 4 illustrated in white and colored dot spaces 5 illustrated in black, and an image pattern is formed by the combination of the uncolored and colored dot spacers 4, 5. The dot spacers 4 are formed of a transparent resin material identical to one used for dot spacers of a conventional touch panel, such as acrylic, epoxy, urethane, polyester thermosetting or photosetting resin, and the dot spacers 5 are formed of the above-mentioned same resin colored by dye or pigment. In the first embodiment, for example, the dot spacers 4, 5 are shaped cylindrical or hemispherical, have a common dimension with a diameter of 30 to 50 μm and a height of 5 to 10 μm, and are arranged regularly at a common spacing interval of 1 mm.

Thus, since the dot spacers 4, 5 of the touch panel 1A of the first embodiment shown in FIGS. 1A and 1B are formed in the same way, material-wise and dimension-wise, as the dot spacers of the conventional touch panel, the touch panel 1A has electrical and mechanical characteristics equivalent to those of the conventional touch panel. However, when the touch panel 1A is disposed over the display screen of an LCD, the dot spacers 4, 5, when noticed by a viewer, are perceived as representing a certain image pattern by the color distinction, unlike the conventional touch panel in which the dot spacers are perceived simply as a group of dots geometrically arranged or randomly distributed. The image pattern can be arranged ad libitum, and therefore it is preferable to use, for example, a popular character image that is expected to appeal agreeably to most of people.

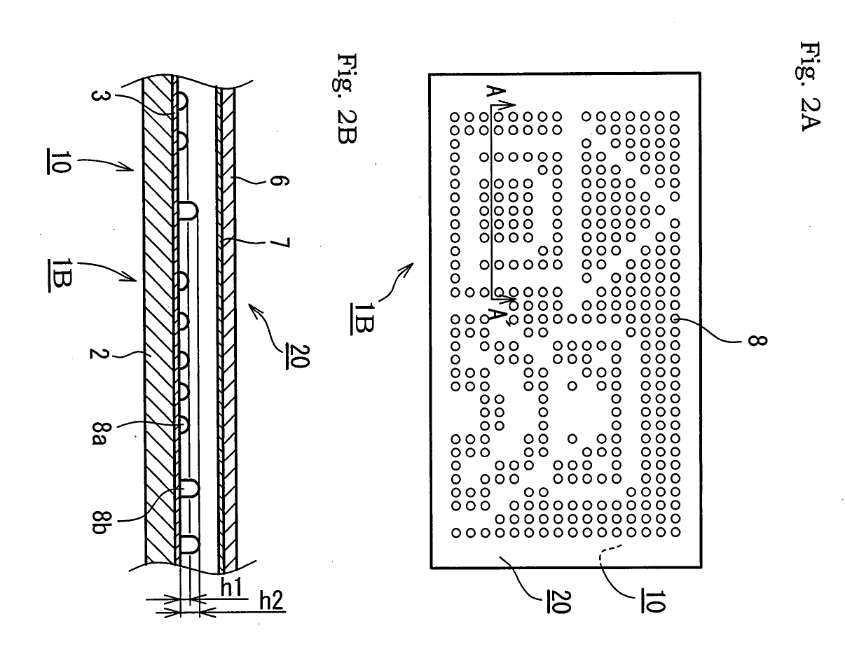

Referring to FIG. 2A, in a touch panel 1B according to a second embodiment, a plurality of dot spacers 8 are distributed at a regular spacing interval entirely with the exception of certain areas constituting voids, whereby difference is generated in distribution density of the dot spacers. The dot spacers 8, when noticed by a viewer, are perceived as representing a certain image pattern by the distribution density difference, unlike the conventional touch panel in which the dot spacers are perceived simply as a group of dots geometrically arranged or randomly distributed. The dot spacers 8 are formed of the above-mentioned same transparent resin material (for example, acrylic, epoxy, urethane, polyester thermosetting or photosetting resin).

The dimension and spacing interval of the dot spacers 8 are appropriately determined according to the electrical and mechanical characteristics required for the touch panel 1B. For example, the height of the dot spacers 8 may vary according to their distribution density. In the second embodiment, as shown in FIG. 2B (dot spacers arranged in a line nearest to the line A-A′ alone are shown), the dot spacers 8 include dot spacers 8a and 8b, and their respective heights h1 and h2 are determined so as to meet a formula h1<h2. The dot spacers 8a with the height h1 are applied where the distribution density is higher (specifically, where the dot spacers 8 are distributed at a regular spacing interval) and the dot spacers 8b with the height h2 are applied where the distribution density is lower (specifically, where the dot spacers 8 are present in the middle of the voids), whereby the pressing force required for causing the first and second conductive layers 3 and 7 to get in contact with each other is uniformed regardless of the distribution density of the dot spacers. The bearing areas of the dot spacers 8a and 8b are preferably uniformed so as to minimize variation in noticeability or visibility. The present embodiment employs two different heights of the dot spacers 8, but three or more different heights may be employed depending on the degree of the distribution density variation of the dot spacers 8.

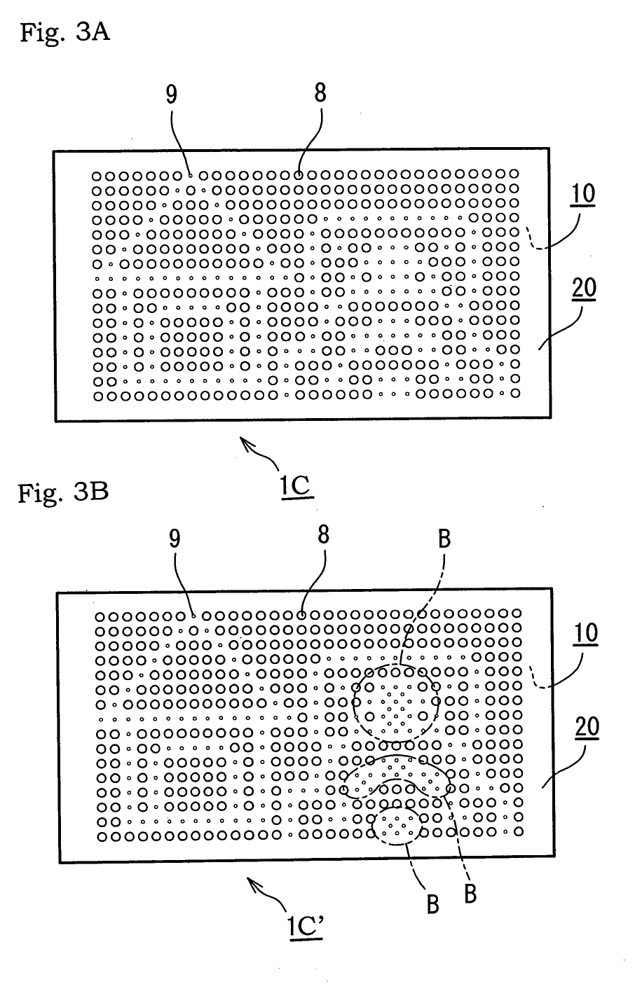

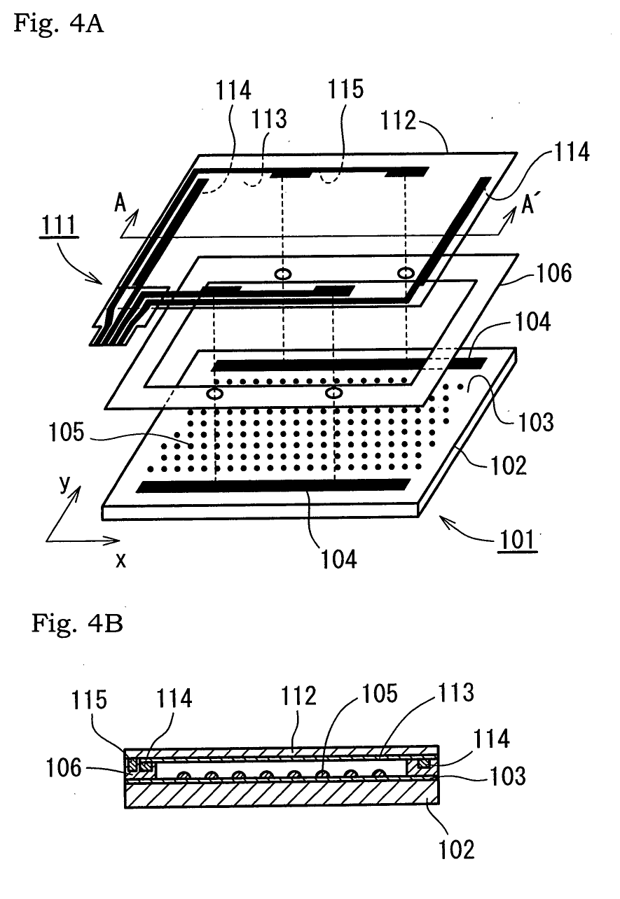

In order to uniform the pressing force required for causing the first and second conductive layers 3 and 7 to get in contact with each other when the dot spacers 8 are arranged with different distribution densities as shown in FIG. 2A, dot spacers with a different dimension may be arranged at areas with a lower distribution density. This constitutes a third embodiment of the present invention. Referring to FIG. 3A, in a touch panel 1C according to the third embodiment, secondary dot spacers 9 having a smaller bearing area than the dot spacers 8 are arranged at areas with a lower distribution density, specifically at voids. The secondary dot spacers 9 are formed of the same material as the dot spacers 8, for example, acrylic, epoxy, urethane, polyester thermosetting or photosetting resin. Since the secondary dot spacers 9 with a smaller bearing area have a smaller scattering area than the dot spacers 8 and are therefore less noticeable, an image pattern can be formed in a way similar to the second embodiment. Further in this connection, referring to FIG. 3B, in a touch panel 1C′ according to a modified version of the third embodiment, the secondary dot spacers 9 may be distributed more densely at larger voids indicated by B.

A preferable method of forming the dot spacers in the touch panels of the present invention will hereinafter be described. The dot spacers are formed on the transparent electrode usually by printing, photolithography, dispensing and the like. Here, methods of screen printing and photolithography are discussed exemplarily to explain the process of forming, but it should be understood that the methods are not exclusive ways to form the dot spacers of the present invention. The two methods, i.e., screen printing and photolithography, enable an image pattern to be formed easily as intended with a relatively high precision, and therefore are suitable for forming the dot spacers of the present invention.

The screen printing method comprises a printing process and a curing process. In the printing process a resin material is extruded by a squeegee from a screen plate with an intended image pattern of dot spacers and is printed on an insulating substrate, and in the curing process the printed resin material of the intended image pattern is heat-cured or photo-cured through exposure to ultra violet radiation depending on the kind of the resin material. When the image pattern is intended to comprise a plurality of colors, a plurality of screen plates having respective patterns corresponding to the colors are prepared, and the printing and curing processes are performed respectively for a number of times corresponding to the number of the colors. In case of the second and third embodiments, when the dot spacers have one same height, only one appropriate screen plate is required and only one each of the printing and curing processes is performed.

The photolithography method, when, for example, a negative photosensitive resin material is used, comprises a coating process, an exposing process, and a developing process. In the coating process the photosensitive resin material is coated on the insulating substrate, in the exposing process a mask with an exposure pattern formed to the intended image pattern is put over the coated photosensitive resin material thereby photo-curing only portions of the photosensitive resin material representing the intended image pattern, and in the developing process the remaining portions thereof left uncured are dissolved by chemicals so as to be removed. When the image pattern is intended to comprise a plurality of colors, a plurality of masks having respective exposure patterns corresponding to the colors are prepared, and the coating, exposing and developing processes are performed for a number of times corresponding to the number of the colors. In case of the second and third embodiments, when the dot spacers have one same height, only one appropriate mask is required and only one each of the coating, exposing and developing processes is performed.

While the present invention has been illustrated and explained with respect to specific preferred embodiments thereof, it is to be understood that the present invention is by no means limited thereto but encompasses all changes and modifications that will become possible within the scope of the appended claims or without departing from the spirit of the present invention. For example, in the embodiments described above, the dot spacers are arranged exactly or substantially in a lattice pattern, which enables the dot spacers to be formed and arranged with no or only slight modification of their conventional dimension and spacing interval, but the dot spacers may alternatively be arranged in any regular or random patterns as required or desired. In such a case, the dimension of the dot spacers and the spacing interval therebetween are appropriately determined in view of the electrical and mechanical characteristics of the touch panel. Also, the dot spacers do not necessarily have to be distributed entirely over the display screen but may alternatively be distributed partly.

1. A touch panel comprising:
first and second transparent electrodes disposed in parallel so as to face each other with a predetermined clearance therebetween; and
a plurality of dot spacers disposed between the first and second transparent electrodes, the plurality of dot spacers being distributed so as to form an image pattern consisting of at least one of a picture, character, symbol and figure.

2. A touch panel according to claim 1, wherein the plurality of dot spacers include a plurality of kinds each having a color different from others, and wherein at least a part of the image pattern is formed by color distinction of the dot spacers.

3. A touch panel according to claim 1, wherein the plurality of dot spacers are distributed with variation in distribution density, and wherein at least a part of the image pattern is formed by the variation in distribution density.

4. A touch panel according to claim 3, wherein dot spacers distributed with a low distribution density have a larger height than dot spacers distributed with a high distribution density.

5. A touch panel according to claim 3, wherein the plurality of dot spacers include primary dot spacers distributed with variation in distribution density and secondary dot spacers having a smaller bearing area than the primary dot spacers and arranged at areas where the primary dot spacers are distributed with a low distribution density.

6. A touch panel-according to claim 2, wherein the plurality of dot spacers are distributed with variation in distribution density, and wherein at least a part of the image pattern is formed by the variation in distribution density.

7. A touch panel according to claim 6, wherein dot spacers distributed with a low distribution density have a larger height than dot spacers distributed with a high distribution density.

8. A touch panel according to claim 7, wherein the plurality of dot spacers include primary dot spacers distributed with variation in distribution density and secondary dot spacers having a smaller bearing area than the primary dot spacers and arranged at areas where the primary dot spacers are distributed with a low distribution density.

9. A touch panel according to claim 6, wherein the plurality of dot spacers include primary dot spacers distributed with variation in distribution density and secondary dot spacers having a smaller bearing area than the primary dot spacers and arranged at areas where the primary dot spacers are distributed with a low distribution density.

10. A touch panel according to claim 4, wherein the plurality of dot spacers include primary dot spacers distributed with variation in distribution density and secondary dot spacers having a smaller bearing area than the primary dot spacers and arranged at areas where the primary dot spacers are distributed with a low distribution density.
